(19) United States
(12) Patent Application Publication
(10) Pub. No.: US 2008/0242800 A1
(43) Pub. Date: Oct. 2, 2008

(54) LOW-EMISSION COLORED POLYOXYMETHYLENE MOLDING COMPOSITION

(75) Inventors: Stefan Disch, Konigsstein (DE); Karl-Friedrich Mueck, Wiesbaden (DE); Lothar Reibmann, Hofheim (DE)

Correspondence Address: Connolly Bove Lodge & Hutz LLP, 1007 North Orange Street, P.O. Box 2207, Wilmington, DE, 19899-2207, US

(73) Assignee: TICONA GmbH, Kelsterbach (DE)

(21) Appl. No.: 12/134,663

(22) Filed: Jun. 6, 2008

Related U.S. Application Data
(63) Continuation of application No. 10/069,087, filed on May 29, 2002, now abandoned.

(30) Foreign Application Priority Data
Aug. 6, 1999 (DE) 19936715.9

(51) Int. Cl. C08L 59/00

(52) U.S. Cl. 524/877

(57) ABSTRACT

Colored molding compositions made from polyacetal copolymer, where the polyacetal copolymer essentially consists of oxymethylene units and oxyethylene units, and a strong protonic acid was used as initiator during preparation of the polyacetal copolymer, have lower formaldehyde emission than that from a comparable molding composition for which the polyacetal copolymer was prepared using a Lewis acid as initiator. The formaldehyde emission is generally less than 20 mg/kg, preferably less than 10 mg/kg.

The present invention relates to colored polyoxymethylene molding compositions which may be used to produce low-emission colored moldings.

Since their introduction to the market about 35 years ago, polyoxymethylenes (POMs) have become established as exceptionally useful engineering materials in a variety of applications. POMs are particularly widely used as an engineering material in automotive construction and in the electrical industry. Examples of these applications may be found in application-oriented brochures of POM producers.

POM copolymers and their preparation are known (Sabel et al. in Becker/Braun eds., Kunststoff-Handbuch [Plastics Handbook] Volume 3/1, Munich, Vienna, 1992). For example, it is known that trioxane can be copolymerized with cyclic ethers, using cationically active initiators. The initiators usually used with cationic action are Lewis acids, such as BF₃, or strong protonic acids, such as perfluoroalkanesulfonic acids, HClO₄, or heteropolyacids. The comonomers usually used are ethylene oxide or the cyclic formal of ethylene glycol, butanediol, or diethylene glycol.

It is known that the POM copolymer formed during the polymerization is suspended in a liquid protic medium to deactivate the initiator, and in the same step of the process unstable chain ends are often eliminated (DE 3703790, DE 3738632, EP 0137305). It is known that the unstable chain ends may also be degraded in homogeneous solution at from 120 to 220° C. (Kunststoff-Handbuch, p. 316). Suitable solvents are water and organic solvents, in particular lower alcohols, trioxane, or dioxolane, or mixtures made from water and organic solvents. After degradation of the unstable chain ends the polymer is precipitated, washed, and dried.

Products made from POM copolymers have long been produced commercially and used for engineering components. A certain level of mechanical properties is required here from POM molding compositions, for example stiffness, hardness, and toughness, which is necessary if these materials are to be used for engineering components, such as gear wheels, levers, and many others. The yield stress values published in the brochures of POM copolymer producers are from 60 to 70 N/mm². The values which they give for the tensile modulus of elasticity of unmodified copolymers are from 2400 to 3100 N/mm². The values found for notch impact strength at 23° C. are from 4 to 12 mJ/mm².

These advantageous properties of POM molding compositions make it necessary to open up new fields of application for these materials. This increasingly leads to the requirement that, besides compliance with the mechanical property profile, moldings have to have only low levels of emission of residual monomers or other volatile constituents. The automotive industry is one of the most important markets for POM products and has developed specific analysis methods for this purpose, for example VDA Empfehlung Nr. 275 [German Automotive Industry Recommendation No. 275], documented by Kraftfahrwesen e.V., July 1994.

The advantageous properties of polyoxymethylenes also make it necessary to extend their use to visible parts, and to open up further fields of application for the material. However, a frequent requirement here is visual matching, i.e. color matching, of the material. To this end, colorants in the form of pigments or polymer-soluble dyes are admixed with the POM molding compositions.

Now, it is generally known (Damm, W. and Herrmann, E., in Gachter, Müller, Plastic Additives, 3^{rd} edition 1989, p. 730), that POM is a particular material which poses special difficulties for coloration. Because this material is sensitive to foreign substances, particularly if these are acidic or have acidic groups, as is often the case with colorants, degradation of the material with subsequent release of formaldehyde can occur during processing, and this severely limits the usefulness of the material. For the reasons mentioned it has hitherto been possible to use only a restricted number of colorants for coloring POM without impairing the properties of the material and of the product. Stabilizers are usually added to suppress degradation of the material in colored POM molding compositions. However, even the addition of stabilizers has hitherto not been able to eliminate the shortcoming of high emission levels. Many stabilizers also impair other properties demanded from the material, for example altering the mechanical property profile, causing mold deposit, impairing high-temperature lightfastness, or giving rise to non-uniform colorant distribution.

Attempts have long been made to overcome these disadvantages.

JP 08208946 adds dicyandiamide as stabilizer to a pigmented polyacetal molding composition. The result is to reduce formaldehyde odor during injection molding, without loss of physical properties. However, dicyandiamide is known to have a tendency toward mold-deposit formation.

JP-04077528 describes the use of POM as a carrier material for pigments. Here, nylon-6 and boric esters as dispersants are also admixed with the mixture. KR-9308188 describes the use of POM as a carrier for conductivity black.

Although the use of POM as a carrier material for pigments is known, as stated above, the existing shortcoming of chemical instability and subsequent formaldehyde evolution during processing and from moldings has not been satisfactorily eliminated while at the same time retaining the required property profile.

It was therefore desirable to develop colored POM molding compositions in which the formaldehyde emission observed hitherto has been substantially reduced, without impairing the known advantageous properties of POM.

The object is in particular achieved by using, as base material for the colored POM molding composition, a polyacetal copolymer which is prepared using a protonic acid to initiate the polymerization.

The invention therefore provides a colored molding composition made from polyacetal copolymer, wherein the polyacetal copolymer essentially consists of oxymethylene units and oxyethylene units, and a strong protonic acid was used as initiator during preparation of the polyacetal copolymer, and the emission of formaldehyde from the colored molding composition is lower than from a molding composition for which the polyacetal copolymer was prepared using a Lewis acid as initiator.

The invention also provides a process for reducing the formaldehyde emission of colored molding compositions made from polyacetal copolymer, which comprises adding colorants selected from the group consisting of white pigments, black pigments, and color pigments to a polyacetal copolymer which essentially consists of oxymethylene units and oxyethylene units, and using a strong protonic acid as initiator for preparing the polyacetal copolymer, and the use of the colored molding composition of the invention for producing moldings with formaldehyde emission of less than 20 mg/kg, preferably less than 10 mg/kg.

Surprisingly, it has been found that colored molding compositions made from POM copolymers which were prepared using strong protonic acids to initiate the polymerization have much lower emission values than those prepared from POM copolymers which were prepared using Lewis acids as initiators.

The POM copolymers used as base material for the colored POM molding compositions essentially contain oxymethylene units and oxyethylene units in the polymer chain. The proportion of the oxyethylene units in the structural units of the polymer chain is from 0.1 to 10 mol %, preferably from 1.0 to 2.5 mol %. The melt index MFI, measured to ISO 1133 at 190° C. and 2.16 kg load, is from 1 to 75 g/10 min, preferably from 13 to 50 g/10 min, and particularly preferably from 25 to 35 g/10 min. The number-average molecular weight determined by GPC is at least 5000 g/mol and not more than 100 000 g/mol.

The POM copolymers to be used according to the invention are prepared using a mixture made from trioxane and a cyclic ether or cyclic acetal, preferably dioxolane or ethylene oxide, a dialkyl formal, preferably methylal, being added to the mixture to adjust the molecular weight. The amount of dialkyl formal added is from 3.4 to 34 mmol, based on the entire monomer mixture. A strong protonic acid, in particular selected from heteropolyacids, perchloric acid, and perfluoroalkanesulfonic acids, or derivatives of these, is added to the reaction mixture to initiate the polymerization. Preference is given here to perfluoroalkanesulfonic acids, in particular trifluoromethanesulfonic acid. The amount of initiator is generally from 0.01 to 1.0 ppm, based on the entire monomer mixture. It is preferable to use from 0.03 to 0.4 ppm, particularly preferably from 0.05 to 0.2 ppm, of initiator. It is advantageous to mix the initiator with an inert solvent and/or with the dialkyl formal used as chain transfer agent, and/or with the comonomer, and to use this mixture to initiate the polymerization.

The POM copolymer obtained during the polymerization is freed from unstable end groups by known methods, washed, and dried.

The colored POM molding compositions of the invention are prepared by mixing the POM copolymer with colorants and the desired stabilizers, and then pelletizing the mixture.

The colored POM molding compositions of the invention advantageously comprise from 90 to 99.8% by weight of POM copolymer which was prepared using a strong protonic acid or a derivative thereof as initiator, from 0.1 to 3.0% by weight of colorants, and from 0.1 to 10% by weight of selected stabilizers and auxiliaries. If required, reinforcing materials and fillers may also be admixed with the molding composition.

The stabilizers and auxiliaries present may be the usual additives for POM, such as antioxidants, UV stabilizers, mold-release agents, acid scavengers, nitrogen-containing costabilizers, and nucleating agents, either individually or as a mixture.

The colorants used may be any desired inorganic pigments, such as titanium dioxide, ultramarine blue, cobalt blue, etc., or organic pigments or colors, such as phthalocyanines, anthraquinones, etc., or carbon black, either individually or as a mixture, or together with polymer-soluble dyes. Indeed, it has been found, surprisingly, that when using the formulation of the invention for the colored polyacetal molding composition, the selection of the colorants is no longer restricted to the conventional colorants particularly suitable for polyacetal, i.e. POM.

The colored POM molding compositions of the invention have a substantially reduced level of emission. For example, formaldehyde emission, measured on sheets of wall thickness 1 mm after 24 h of storage to VDA 275 is generally less than 20 mg/kg, preferably less than 10 mg/kg. Some of the stabilizers usually used in POM copolymers, for example nitrogen-containing costabilizers and acid scavengers, affect formaldehyde emission. The colored POM molding compositions of the invention have substantially lower emission values than the prior art at the same level of stabilization. The addition of stabilizers can therefore be reduced markedly for the colored POM molding compositions of the invention, and costs can thus be saved.

Under some circumstances, it can also be advantageous to provide the colorants, prior to mixing with the polyacetal copolymer, with a coating which comprises 3% by weight or more, based on the amount of pigment, of an alkali metal salt of a fatty acid having at least 12 carbon atoms, preferably from 12 to 30 carbon atoms, for example a sodium stearate or potassium stearate. This can give a further reduction in the tendency of colored polyacetal copolymers to produce emissions.

The mechanical properties of the molding compositions of the invention comply with the usual requirements placed upon commercially available POM products; they can therefore be used without restriction in the fields of application and processing technologies which are usual for POM.

Particular fields of application for the molding compositions of the invention are internal fittings and claddings for means of transport, such as automobiles, aircraft, etc., household products, toys, items for babies, and also devices and components for electrical engineering or electronics. The novel molding compositions are particularly suitable for producing low-emission apparatus or instruments, or parts of these, for medical applications.

### EXAMPLES

The methods used to determine the properties of the material in the following examples were as follows:

Melt index (MFI) to ISO 1133 at 190° C. and 2.16 kg load

Tensile modulus of elasticity to ISO 527

Yield stress to ISO 527

### Notch Impact Strength to ISO 179

Formaldehyde emission: Sheets of wall thickness 1 mm were manufactured from the colored POM molding compositions. After storage for 24 h, the formaldehyde emission from the sheets was determined to VDA 275 (VDA Empfehlung Nr. 275 [German Automotive Industry Recommendation No. 275], documented by Kraftfahrwesen e.V., July 1994).

The results from material testing in the examples below are given in table 1.

The pigment mixtures used in the examples were as follows:

Pigment mixture (1): composed of 53% by weight of titanium dioxide, 39% by weight of Renol black, 6.3% by weight of titanium orange, and 1.7% by weight of ekea red.

Pigment mixture (2): composed of 39.3% by weight of manganese violet VM 40, 4.4% of titanium dioxide, 54.7% of ivory black 64, 1.6% of ultramarine blue 53.

### POM Copolymer of the Invention

96.6% by weight of trioxane, 3.4% by weight of dioxolane, and 1000 ppm of methylal were charged to a batch reactor at a temperature of 80° C. and a pressure of about 1 bar. 0.2 ppm of trifluoromethanesulfonic acid dissolved in 500 ppm of methylal were added to this mixture. The amounts given are based on the entire monomer mixture. After an induction time of 30 seconds, the polymerization reaction began. The crude polymer formed was suspended in a water/triethylamine mixture and then hydrolyzed at 170° C. in a water/methanol (10/90) mixture. On cooling to room temperature the polymer precipitated as a fine powder. The polymer was isolated by filtration with suction, washed with water, and dried.

### Comparative POM Copolymer

96.6% by weight of trioxane, 3.4% by weight of dioxolane, and 800 ppm of methylal were charged, the reaction conditions being as in example 1. To this mixture were added 30 ppm of BF₃, based on the entire monomer mixture. The polymerization reaction started after an induction time of 20 s. The polymer was worked up as for the base material of the invention.

### Example 1

The POM copolymer of the invention was mixed with 1% by weight of pigment mixture 1 and with 0.1% by weight of Licowax C (producer: Clariant AG), 0.1% by weight of calcium citrate, and 0.1% by weight of Irganox 1010. Pellets were produced from the mixture and were injection molded to give the test specimens for determining tensile modulus of elasticity, yield stress, and notch impact strength, and also to give the sheets for determining formaldehyde emission.

### Example 1a

Example 1 was repeated except that the POM copolymer of the invention was initiated using trifluoromethanesulfonic anhydride.

### Comparative Example 1

The comparative POM copolymer was mixed with 1% by weight of pigment mixture 1 and with antioxidant, acid scavenger, and additives, their proportions being as in example 1. Pellets were produced from the mixture and were injection molded to give the test specimens for determining tensile modulus of elasticity, yield stress, and notch impact strength, and also to give the sheets for determining formaldehyde emission.

### Example 2

The POM copolymer of the invention was mixed with 1% by weight of pigment mixture 2 and with 0.1% by weight of Licowax C, 0.1% by weight of calcium citrate, and 0.1% by weight of Irganox 1010. Pellets were produced from the mixture and were injection molded to give the test specimens for determining tensile modulus of elasticity, yield stress, and notch impact strength, and also to give the sheets for determining formaldehyde emission.

### Comparative Example 2

The comparative POM copolymer was mixed with 1% by weight of pigment mixture 2 and with antioxidant, acid scavenger, and additives, their proportions being as in example 2. Pellets were produced from the mixture and were injection molded to give the test specimens for determining tensile modulus of elasticity, yield stress, and notch impact strength, and also to give the sheets for determining formaldehyde emission.

### Example 3

The ᵢPOM copolymer of the invention was mixed with 1% by weight of pigment mixture 1, and with 0.1% by weight of Licowax C, and 0.1% by weight of melamine. Pellets were produced from the mixture and were injection molded to give the test specimens for determining tensile modulus of elasticity, yield stress, and notch impact strength, and also to give the sheets for determining formaldehyde emission.

### Comparative Example 3

The comparative POM copolymer was mixed with 1% by weight of pigment mixture 1 and with additives, their proportions being as in example 3. Pellets were produced from the mixture and Were injection molded to give the test specimens for determining tensile modulus of elasticity, yield stress, and notch impact strength, and also to give the sheets for determining formaldehyde emission.

TABLE 1

| | Melt index | Modulus of elasticity | Yield stress | Notch impact strength | VDA 275* |
|---|---|---|---|---|---|
| | g/10 min | N/mm² | N/mm² | mJ/mm² | mg/kg |
| POM copolymer of the | 27 | — | — | — | — |
| invention | | | | | |
| Comparative POM | 27 | — | — | — | — |
| copolymer | | | | | |
| Example 1 | 25 | 2800 | 64 | 7 | 17 |
| Example 1a | 26 | 2750 | 66 | 6.5 | 15 |
| Comparative Example 1 | 24 | 2920 | 66 | 6.5 | 43 |
| Example 2 | 26 | 2770 | 64 | 7.5 | 15 |
| Comparative Example 2 | 27 | 2890 | 65 | 7 | 63 |
| Example 3 | 23 | 2770 | 64 | 7 | 8.5 |
| Comparative Example 3 | 24 | 2900 | 66 | 6.5 | 24 |

*Formaldehyde emission to VDA 275

1-10. (canceled)

11. A colored molding composition which comprises a polyacetal copolymer, wherein the polyacetal copolymer consisting essentially of oxymethylene units and oxyethylene units, and strong protonic acid and/or a derivative of a strong protonic acid was used as initiator during preparation of the polyacetal copolymer, and a colorant, and the emission of formaldehyde from the colored molding composition is lower than from a molding composition for which the polyacetal copolymer was prepared using a Lewis acid as initiator and wherein the formaldehyde emission, determined on test specimens in accordance with the German Automotive Industry Recommendation No. 275 (VDA 275), is not more than 20 mg/kg.

12. The molding composition as claimed in claim 11, which comprises from 0.1 to 3.0% by weight of colorants selected from the group consisting of white pigments, black pigments, and color pigments.

13. The molding composition as claimed in claim 12, wherein the colorants carry a coating of an alkali metal salt of a fatty acid having at least 12 carbon atoms.

14. The molding composition as claimed in claim 11, wherein the polyacetal copolymer comprises from 0.1 to 10 mol % of oxyethylene units.

15. The molding composition as claimed in claim 11, wherein the formaldehyde emission, determined on test specimens in accordance with the German Automotive Industry Recommendation No. 275 (VDA 275), is not more than 60% of the formaldehyde emission of a colored molding composition for which the polyacetal copolymer was prepared using BF₃ as the initiator.

16. The molding composition as claimed in claim 11, which further comprises from 0.1 to 10% by weight of stabilizers and auxiliaries.

17. A process to prepare a molding composition which comprises preparing a polyacetal copolymer which consisting essentially of oxymethylene units and oxyethylene units, using trifluoromethanesulfonic acid and/or a derivative of trifluoromethanesulfonic acid as an initiator, mixing the polyacetal copolymer with at least one colorant selected from the group consisting of white pigments, black pigments and color pigments, and obtaining a colored polyacetal molding composition whose emission of formaldehyde is lower than from a molding composition for which the polyacetal copolymer was prepared using a Lewis acid as an initiator and wherein the formaldehyde emission, determined on test specimens in accordance with the German Automotive Industry Recommendation No. 275 (VDA 275), is not more than 20 mg/kg.

18. The process as claimed in claim 17, wherein said colorant is in an amount from 0.1 to 3.0% by weight.

19. The process as claimed in claim 18, wherein the colorant carries a coating of an alkali metal salt of a fatty acid having at least 12 carbon atoms.

20. The process as claimed in claim 17, wherein the polyacetal copolymer comprises from 0.1 to 10 mol % of oxyethylene units.

21. The process as claimed in claim 17, wherein the formaldehyde emission, determined on test specimens in accordance with the German Automotive Industry Recommendation No. 275 (VDA 275), is not more than 60% of the formaldehyde emission of a colored molding composition for which the polyacetal copolymer was prepared using BF₃ as initiator.

22. The process as claimed in claim 17, which further comprises from 0.1 to 10% by weight of stabilizers and auxiliaries.

23. The process as claimed in claim 18, wherein the polyacetal copolymer comprises from 1.0 to 2.5 mol % of oxyethylene units.

24. The process as claimed in claim 17, wherein the formaldehyde emission, determined on test specimens in accordance with the German Automotive Industry Recommendation No. 275 (VDA 275), is not more than 50% of the formaldehyde emission of a colored molding composition for which the polyacetal copolymer was prepared using BF₃ as the initiator.

25. The process as claimed in claim 17, wherein the formaldehyde emission, determined on test specimens in accordance with the German Automotive Industry Recommendation No. 275 (VDA 275), is less than 10 mg/kg.

26. A process for reducing the formaldehyde emission of colored molding compositions made from polyacetal copolymer, which comprises preparing a polyacetal copolymer consisting essentially of oxymethylene units and oxyethylene units, using trifluoromethanesulfonic acid and/or a derivative of trifluoromethanesulfonic acid as an initiator, mixing the polyacetal copolymer with at least one colorant selected from the group consisting of white pigments, black pigments and color pigments, and obtaining a colored polyacetal molding composition whose emission of formaldehyde is lower than from a molding composition for which the polyacetal copolymer was prepared using a Lewis acid as initiator.

27. The process as claimed in claim 26, wherein when the initiator is added in a solvent.

28. The molding composition as claimed in claim 19, wherein the polyacetal copolymer comprises from 0.1 to 10 mol % of oxyethylene units and the formaldehyde emission, determined on test specimens in accordance with the German Automotive Industry Recommendation No. 275 (VDA 275), is not more than 60% of the formaldehyde emission of a colored molding composition for which the polyacetal copolymer was prepared using BF₃ as the initiator.

29. The molding composition as claimed in claim 28, which further comprises from 0.1 to 10% by weight of stabilizers and auxiliaries.
